(19) United States
(12) Patent Application Publication
(10) Pub. No.: US 2014/0066535 A1
(43) Pub. Date: Mar. 6, 2014

(54) METHOD FOR PRODUCING FLEXIBLE POLYURETHANE FOAM MATERIALS

(71) Applicants: Gundolf Jacobs, Rosrath (DE); Sven Meyer-Ahrens, Leverkusen (DE); Bert Klesczewski, Koln (DE); Angelika Schulz, Leverkusen (DE)

(72) Inventors: Gundolf Jacobs, Rosrath (DE); Sven Meyer-Ahrens, Leverkusen (DE); Bert Klesczewski, Koln (DE); Angelika Schulz, Leverkusen (DE)

(73) Assignee: Bayer Intellectual Property GmbH, Monheim (DE)

(21) Appl. No.: 14/007,442

(22) PCT Filed: Mar. 23, 2012
(86) PCT No.: PCT/EP2012/055221

§ 371 Date: Oct. 23, 2013

(30) Foreign Application Priority Data
Mar. 28, 2011 (EP) 11159965.0

(51) Int. Cl. C08L 75/04; C08G 71/04

(52) U.S. Cl. CPC C08L 75/04; C08G 71/04
USPC 521/159; 528/59

(57) ABSTRACT

The present invention relates to a method for producing flexible polyurethane foams, wherein an isocyanate component (component B) is used which comprises polyether carbonate polyol, and to the isocyanate component itself. The invention also provides an NCO-terminated, urethane group-comprising prepolymer obtainable by reaction of one or more polyisocyanates (B1) with one or more polyether carbonate polyols.

The present invention relates to a method for producing flexible polyurethane foams, wherein an isocyanate component (component B) is used which comprises polyether carbonate polyol, and to the isocyanate component itself.

The production of polyether carbonate polyols by catalytic conversion of alkylene oxides (epoxides) and carbon dioxide in the presence or absence of H-functional starter substances (starters) has been the subject of intensive research for more than 40 years. This reaction, e.g. using an H-functional starter compound, is illustrated diagrammatically in diagram (I), wherein R denotes an organic residue such as alkyl, alkylaryl or aryl, each of which can also comprise heteroatoms such as e.g. O, S, Si etc., and wherein e and f denote a whole number, and wherein the product shown here in diagram (I) for the polyether carbonate polyol is only to be understood such that blocks with the structure shown can in principle be found in the polyether carbonate polyol obtained, but the sequence, number and length of the blocks and the OH functionality of the starter can vary and is not limited to the polyether carbonate polyol shown in diagram (I). This reaction (cf. diagram (I)) is ecologically very advantageous, since this reaction represents the conversion of a greenhouse gas such as CO₂ to a polymer. As a further product, actually a by-product, the cyclic carbonate shown in formula (I) is formed (e.g. for R═CH₃ propylene carbonate).

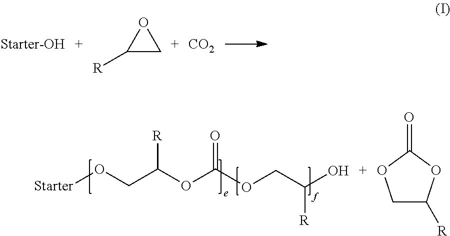

EP-A 0 222 453 discloses a method for producing polyether carbonate polyol from alkylene oxides and carbon dioxide using a catalyst system comprising DMC catalyst and a co-catalyst such as zinc sulfate and the production of flexible polyurethane foams, wherein the polyether carbonate polyol was used as a constituent of the polyol component.

WO-A 2008/058913 discloses a method for the of flexible polyurethane foams, wherein a polyether carbonate polyol was used as a constituent of the polyol component.

For the production of flexible polyurethane foams, in particular of moulded flexible polyurethane foams, by the cold foaming process, polyols are needed which have relatively high reactivity and thus generally have a proportion of primary OH groups of over 65 mole % (cf. Polyurethane, Kunststoffhandbuch, Dr. G. Oertel, ed. G. W. Becker, D. Braun, 3^{rd} edition, 1993, chapter 5.3.1). Suitable polyether polyols or polyether carbonate polyols for the cold foaming process are therefore generally capped with 5 to 25 wt. % ethylene oxide (i.e. these polyols have 5 to 25 wt. % terminal blocks of ethylene oxide units). Presumably owing to the high reactivity of DMC catalysts and of ethylene oxide, however, polyether carbonate polyols with 5 to 25 wt. % terminal ethylene oxide units which can be used for the production of flexible polyurethane foams cannot be produced industrially with the aid of DMC catalysts. On the other hand, polyether carbonate polyols having no or less than 5 wt. % terminal blocks of ethylene oxide units lead to an unsatisfactory result in the cold foaming process.

The object of the present invention was to provide a method for producing flexible polyurethane foams by the cold foaming process, wherein polyether carbonate polyols can be used which were produced in the presence of DMC catalysts. In particular, it should also be possible to use polyether carbonate polyols having no or less than 5 wt. % terminal blocks of ethylene oxide units. The resulting flexible polyurethane foams should have at least comparable mechanical properties to flexible polyurethane foams produced from polyether polyols and without polyether carbonate polyols.

Surprisingly, it has been found that the above-mentioned object is achieved by a method for producing flexible polyurethane foams by reaction of component A (polyol formulation) comprising
A1 100 parts by weight polyether polyol,
A2 0.5 to 25 parts by weight, preferably 2 to 5 parts by weight (based on 100 parts by weight of component A1) water and/or physical blowing agents,
A3 0.05 to 10 parts by weight, preferably 0.2 to 4 parts by weight (based on 100 parts by weight of component A1) auxiliary substances and additives such as
   a) catalysts,
   b) surface-active additives,
   c) pigments or flame retardants,
A4 0 to 10 parts by weight, preferably 0.05 to 5 parts by weight (based on 100 parts by weight of component A1) isocyanate-reactive compounds comprising hydrogen atoms having a molecular weight of 62-399,

with component B comprising one or more polyisocyanates (B1) and one or more polyether carbonate polyols (B2),

the production taking place at an index of 50 to 250, preferably 70 to 130, particularly preferably 75 to 115.

The present invention also provides a method for producing flexible polyurethane foams, characterised in that
(i) in a first step, one or more alkylene oxides and carbon dioxide are added to one or more H-functional starter substances in the presence of at least one DMC catalyst (“copolymerisation”),
(ii) in a second step, one or more polyisocyanates (B1) are reacted with polyether carbonate polyol (B2) resulting from step (i) to form an NCO-terminated, urethane group-comprising prepolymer (B), and
(iii) in a third step, the production of flexible polyurethane foams takes place by reaction of component A (polyol formulation) comprising
   A1 100 parts by weight polyether polyol,
   A2 0.5 to 25 parts by weight, preferably 2 to 5 parts by weight (based on 100 parts by weight of component A1) water and/or physical blowing agents,
   A3 0.05 to 10 parts by weight, preferably 0.2 to 4 parts by weight (based on 100 parts by weight of component A1) auxiliary substances and additives such as
      a) catalysts,
      b) surface-active additives,
      c) pigments or flame retardants,
   A4 0 to 10 parts by weight, preferably 0.05 to 5 parts by weight (based on 100 parts by weight of component A1) isocyanate-reactive compounds comprising hydrogen atoms with a molecular weight of 62-399,
   with component B resulting from step (ii),
   the production of the flexible polyurethane foams taking place at an index of 50 to 250, preferably 70 to 130, particularly preferably 75 to 115.

The invention thus also provides a method for producing NCO-terminated, urethane group-comprising prepolymers, characterised in that
(i) in a first step, one or more alkylene oxides and carbon dioxide are added to one or more H-functional starter substances in the presence at least one DMC catalyst (“copolymerisation”), and
(ii) in a second step, one or more polyisocyanates (B1) are reacted with polyether carbonate polyol (B2) resulting from step (i).

The flexible polyurethane foams according to the invention preferably have a density according to DIN EN ISO 3386-1-98 in the range of ≧10 kg/m³ to ≦300 kg/m³, preferably of ≧30 kg/m³ to ≦100 kg/m³, and in general their compressive strength according to DIN EN ISO 3386-1-98 is in the range of ≧0.5 kPa to ≦20 kPa (at 40% deformation and 4^{th} cycle).

Component A (Polyol Formulation)

The method according to the invention is distinguished by the fact that the polyol formulation is free from polyether carbonate polyols. The individual components A1 to A4 of the polyol formulation are explained below.

Component A1

Starting components according to component A1 are polyether polyols. Polyether polyols within the meaning of the invention refer to compounds which are alkylene oxide addition products of starter compounds with Zerewitinoff-active hydrogen atoms, i.e. polyether polyols with a hydroxyl value according to DIN 53240 of ≧15 mg KOH/g to ≦80 mg KOH/g, preferably of ≧20 mg KOH/g to ≦60 mg KOH/g.

Starter compounds with Zerewitinoff-active hydrogen atoms used for the polyether polyols usually have functionalities of 2 to 6, preferably of 3, and the starter compounds are preferably hydroxyfunctional. Examples of hydroxyfunctional starter compounds are propylene glycol, ethylene glycol, diethylene glycol, dipropylene glycol, 1,2-butanediol, 1,3-butanediol, 1,4-butanediol, hexanediol, pentanediol, 3-methyl-1,5-pentanediol, 1,12-dodecanediol, glycerol, trimethylolpropane, triethanolamine, pentaerythritol, sorbitol, sucrose, hydroquinone, pyrocatechol, resorcinol, bisphenol F, bisphenol A, 1,3,5-trihydroxybenzene, methylol group-comprising condensates of formaldehyde and phenol or melamine or urea. Glycerol and/or trimethylolpropane is preferably used as the starter compound.

Suitable alkylene oxides are e.g. ethylene oxide, propylene oxide, 1,2-butylene oxide or 2,3-butylene oxide and styrene oxide. Preferably, propylene oxide and ethylene oxide are fed into the reaction mixture individually, in a mixture or consecutively. If the alkylene oxides are metered in consecutively, the products that are produced comprise polyether chains with block structures. Products with ethylene oxide blocks are characterised e.g. by elevated concentrations of primary end groups, which provide the systems with an advantageous isocyanate reactivity.

Component A2

As component A2, water and/or physical blowing agents are used. As physical blowing agents, e.g. carbon dioxide and/or volatile organic substances are used as blowing agents.

Component A3

As component A3, auxiliary substances and additives are employed, such as
a) catalysts (activators),
b) surface-active additives (surfactants), such as emulsifiers and foam stabilisers, in particular those with low fogging such as e.g. products from the Tegostab® LF range,
c) additives such as reaction inhibitors (e.g. substances reacting acidically, such as hydrochloric acid or organic acid halides), cell regulators (such as e.g. paraffins or fatty alcohols or dimethyl polysiloxanes), pigments, dyes, flame retardants (such as e.g. tricresyl phosphate), stabilisers against the effects of ageing and weathering, plasticisers, substances with fungistatic and bacteriostatic action, fillers (such as e.g. barium sulfate, kieselguhr, carbon black or whiting) and mould release agents.

These auxiliary substances and additives which may optionally be incorporated are described e.g. in EP-A 0 000 389, pp. 18-21. Further examples of auxiliary substances and additives which may optionally be incorporated according to the invention together with details of the application and mode of action of these auxiliary substances and additives are described in Kunststoff-Handbuch, volume VII, edited by G. Oertel, Carl-Hanser-Verlag, Munich, 3^{rd} edition, 1993, e.g. on pp. 104-127.

Aliphatic tertiary amines (e.g. trimethylamine, tetramethyl butanediamine), cycloaliphatic tertiary amines (e.g. 1,4-diaza[2.2.2]bicyclooctane), aliphatic amino ethers (e.g. dimethylaminoethyl ether and N,N,N-trimethyl-N-hydroxyethyl-bisaminoethyl ether), cycloaliphatic amino ethers (e.g. N-ethylmorpholine), aliphatic amidines, cycloaliphatic amidines, urea, derivatives of urea (such as e.g. aminoalkyl ureas, cf. for example EP-A 0 176 013, in particular (3-dimethylaminopropylamine)urea) and tin catalysts (such as e.g. dibutyltin oxide, dibutyltin dilaurate, tin octoate) are preferred as catalysts.

Particularly preferred as catalysts are
α) urea, derivatives of urea and/or
β) amines and amino ethers, which each comprise a functional group that reacts chemically with isocyanate. The functional group is preferably a hydroxyl group or a primary or secondary amino group. These particularly preferred catalysts have the advantage that they exhibit markedly reduced migration and emission behaviour.

The following may be mentioned as examples of particularly preferred catalysts: (3-dimethylaminopropylamine)urea, 2-(2-dimethylaminoethoxy)ethanol, N,N-bis(3-dimethylaminopropyl)-N-isopropanolamine, N,N,N-trimethyl-N-hydroxyethylbis-aminoethyl ether and 3-dimethylaminopropylamine.

Component A4

Compounds with at least two isocyanate-reactive hydrogen atoms and a molecular weight of 32 to 399 are optionally used as component A4. These are understood to be compounds comprising hydroxyl groups and/or amino groups and/or thiol groups and/or carboxyl groups, preferably compounds comprising hydroxyl groups and/or amino groups, which act as chain extenders or crosslinking agents. These compounds generally comprise 2 to 8, preferably 2 to 4, isocyanate-reactive hydrogen atoms. For example, ethanolamine, diethanolamine, triethanolamine, sorbitol and/or glycerol can be used as component A4. Further examples of compounds according to component A4 are described in EP-A 0 007 502, pp. 16-17.

Component B

Component B within the meaning of the invention is an NCO-terminated, urethane group-comprising prepolymer obtainable by reaction of one or more polyisocyanates (B1) with one or more polyether carbonate polyols (B2). The urethane group-comprising prepolymer according to component B preferably has an NCO content of 5 to 31 wt. %, particularly preferably of 12 to 31 wt. %, most preferably of 25 to 30 wt. %.

Components B1 and B2 are preferably reacted by the methods that are known per se to the person skilled in the art. For example, components B1 and B2 can be mixed at a temperature of 20 to 80° C., forming the urethane group-comprising prepolymer. In general, the reaction of components B1 and B2 is ended after 30 min to 24 h with formation of the NCO-terminated, urethane group-comprising prepolymer. Activators known to the person skilled in the art for the production of the NCO-terminated, urethane group-comprising prepolymer may optionally be used.

In a particularly preferred embodiment, the urethane group-comprising prepolymer according to component B with an NCO content of 5 to 31 wt. %, particularly preferably of 12 to 30 wt. %, most preferably of 15 to 29 wt. %, is produced by reaction of
B1) polyisocyanate consisting of at least one component selected from the group consisting of 4,4′-diphenylmethane diisocyanate, 2,4′-diphenylmethane diisocyanate, 2,2′-diphenylmethane diisocyanate and polyphenyl polymethylene polyisocyanate with
B2) polyether carbonate polyol.

The urethane group-comprising prepolymer according to component B can also be produced in that firstly, by reaction of a first partial quantity of one or more polyisocyanates (B1) with one or more polyether carbonate polyols (B2), a urethane group-comprising prepolymer is obtained which is then mixed in a further step with a second partial quantity of one or more polyisocyanates (B1) to obtain the urethane group-comprising prepolymer according to component B with an NCO content of 5 to 31 wt. %, particularly preferably of 12 to 30 wt. %, most preferably of 15 to 29 wt. %.

Component B1

Suitable polyisocyanates are aliphatic, cycloaliphatic, araliphatic, aromatic and heterocyclic polyisocyanates, as described e.g. by W. Siefken in Justus Liebigs Annalen der Chemie, 562, pp. 75 to 136, e.g. those of formula (I)

Q(NCO)ₙ, (I)
in which
n=2-4, preferably 2-3,
and
Q signifies an aliphatic hydrocarbon residue with 2-18, preferably 6-10 C atoms, a cycloaliphatic hydrocarbon residue with 4-15, preferably 6-13 C atoms or an araliphatic hydrocarbon residue with 8-15, preferably 8-13 C atoms.

For example, they are those polyisocyanates as described in EP-A 0 007 502, pp. 7-8. In general, the polyisocyanates that can be readily obtained industrially are preferred, e.g. 2,4- and 2,6-toluene diisocyanate, as well as any mixtures of these isomers (“TDI”); polyphenyl polymethylene polyisocyanates, as are produced by aniline-formaldehyde condensation and subsequent phosgenation (“crude MDI”) and polyisocyanates comprising carbodiimide groups, urethane groups, allophanate groups, isocyanurate groups, urea groups or biuret groups (“modified polyisocyanates”), in particular those modified polyisocyanates that are derived from 2,4- and/or 2,6-toluene diisocyanate or from 4,4′- and/or 2,4′-diphenylmethane diisocyanate. Preferably, at least one compound selected from the group consisting of 2,4- and 2,6-toluene diisocyanate, 4,4′- and 2,4′- and 2,2′-diphenylmethane diisocyanate and polyphenyl polymethylene polyisocyanate (“polynuclear MDI”) is used as the polyisocyanate and particularly preferably, a mixture comprising 4,4′-diphenylmethane diisocyanate, 2,4′-diphenylmethane diisocyanate and polyphenyl polymethylene polyisocyanate is used as the polyisocyanate.

Component B2

Polyether carbonate polyol is used as component B2. The polyether carbonate polyol are preferably produced by adding one or more alkylene oxides and carbon dioxide to one or more H-functional starter substances in the presence of at least one DMC catalyst (“copolymerisation”). The polyether carbonate polyols preferably have an OH functionality of 1 to 8, particularly preferably of 2 to 6 and most particularly preferably of 2 to 4. The molecular weight is preferably 400 to 10000 g/mol and particularly preferably 500 to 6000 g/mol.

For example, the method for producing polyether carbonate polyol is characterised in that
(α) the H-functional starter substance or a mixture of at least two H-functional starter substances is presented and optionally water and/or other volatile compounds are removed by elevated temperature and/or reduced pressure (“drying”), the DMC catalyst being added to the H-functional starter substance or the mixture of at least two H-functional starter substances before or after the drying,
(β) for the purpose of activation, a partial quantity (based on the total quantity of the quantity of alkylene oxides used during activation and copolymerisation) of one or more alkylene oxides is added to the mixture resulting from step (α), this addition of a partial quantity of alkylene oxide optionally taking place in the presence of CO₂ and then the temperature peak (“hotspot”) that occurs as a result of the subsequent exothermic chemical reaction and/or a pressure drop in the reactor being awaited in each case, and step (β) for the activation also optionally taking place multiple times,
(γ) one or more alkylene oxides and carbon dioxide are added to the mixture resulting from step (β), the alkylene oxides used in step (γ) being the same as or different from the alkylene oxides used in step (β).

Activation within the meaning of the invention refers to a step in which a partial quantity of alkylene oxide compound is added to the DMC catalyst, optionally in the presence of CO₂, and then the addition of the alkylene oxide compound is interrupted, wherein as a result of a subsequent exothermic chemical reaction a temperature peak (“hotspot”) and/or a pressure drop in the reactor is observed. The activation step of the method is the period from the addition of the partial quantity of alkylene oxide compound to the DMC catalyst, optionally in the presence of CO₂, up to the hotspot. In general, the activation step can be preceded by a step for the drying of the DMC catalyst and optionally of the starter by elevated temperature and/or reduced pressure, this drying step not being part of the activation step within the meaning of the present invention.

In general, alkylene oxides (epoxides) with 2-24 carbon atoms can be used for the method according to the invention. The alkylene oxides with 2-24 carbon atoms are e.g. one or more compounds selected from the group consisting of ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, mono- or polyepoxidised fats as mono-, di- and triglycerides, epoxidised fatty acids, C₁-C₂₄ esters of epoxidised fatty acids, epichlorohydrin, glycidol and derivatives of glycidol, such as e.g. methyl glycidyl ether, ethyl glycidyl ether, 2-ethylhexyl glycidyl ether, allyl glycidyl ether, glycidyl methacrylate and epoxy-functional alkoxysilanes, such as e.g. 3-glycidyloxypropyltrimethoxysilane, 3-glycidyloxypropyltriethoxysilane, 3-glycidyloxypropyltripropoxysilane, 3-glycidyloxypropylmethyldimethoxysilane, 3-glycidyloxypropylethyldiethoxysilane and 3-glycidyloxypropyltriisopropoxysilane. Ethylene oxide and/or propylene oxide, in particular propylene oxide, are preferably used as alkylene oxides.

As a suitable H-functional starter substance, compounds with H atoms that are active for alkoxylation can be used. Active groups for alkoxylation with active H atoms are e.g. —OH, —NH₂ (primary amines), —NH— (secondary amines), —SH and —CO₂H; —OH and —NH₂ are preferred and —OH is particularly preferred. As the H-functional starter substance, e.g. one or more compounds are used selected from the group consisting of mono- or polyhydric alcohols, polyvalent amines, polyvalent thiols, amino alcohols, thio alcohols, hydroxy esters, polyether polyols, polyester polyols, polyester ether polyols, polyether carbonate polyols, polycarbonate polyols, polycarbonates, polyethylene imines, polyether amines (e.g. so-called Jeffamines® from Huntsman, such as e.g. D-230, D-400, D-2000, T-403, T-3000, T-5000 or corresponding products from BASF, such as e.g. polyether amine D230, D400, D200, T403, T5000), polytetrahydrofurans (e.g. PolyTHF® from BASF, such as e.g. PolyTHF® 250, 650S, 1000, 1000S, 1400, 1800, 2000), polytetrahydrofuranamines (BASF product Polytetrahydrofuranamine 1700), polyether thiols, polyacrylate polyols, castor oil, the mono- or diglyceride of ricinoleic acid, monoglycerides of fatty acids, chemically modified mono-, di- and/or triglycerides of fatty acids, and C₁-C₂₄ alkyl fatty acid esters which comprise on average at least 20H groups per molecule. The C₁-C₂₄ alkyl fatty acid esters which comprise on average at least 2 OH groups per molecule are, for example, commercial products such as Lupranol Balance® (BASF AG), Merginol® grades (Hobum Oleochemicals GmbH), Sovermol® grades (Cognis Deutschland GmbH & Co. KG) and Soyol®™ grades (USSC Co.).

As monofunctional starter compounds, alcohols, amines, thiols and carboxylic acids can be used. The following can be used as monofunctional alcohols: methanol, ethanol, 1-propanol, 2-propanol, 1-butanol, 2-butanol, tert-butanol, 3-buten-1-ol, 3-butyn-1-ol, 2-methyl-3-buten-2-ol, 2-methyl-3-butyn-2-ol, propargyl alcohol, 2-methyl-2-propanol, 1-tert-butoxy-2-propanol, 1-pentanol, 2-pentanol, 3-pentanol, 1-hexanol, 2-hexanol, 3-hexanol, 1-heptanol, 2-heptanol, 3-heptanol, 1-octanol, 2-octanol, 3-octanol, 4-octanol, phenol, 2-hydroxybiphenyl, 3-hydroxybiphenyl, 4-hydroxybiphenyl, 2-hydroxypyridine, 3-hydroxypyridine and 4-hydroxypyridine. The following are suitable as monofunctional amines: butylamine, tert-butylamine, pentylamine, hexylamine, aniline, aziridine, pyrrolidine, piperidine and morpholine. As monofunctional thiols it is possible to use: ethanethiol, 1-propanethiol, 2-propanethiol, 1-butanethiol, 3-methyl-1-butanethiol, 2-butene-1-thiol and thiophenol. The following may be mentioned as monofunctional carboxylic acids: formic acid, acetic acid, propionic acid, butyric acid, fatty acids, such as stearic acid, palmitic acid, oleic acid, linoleic acid, linolenic acid, benzoic acid and acrylic acid.

Suitable polyhydric alcohols as H-functional starter substances are e.g. dihydric alcohols (such as e.g. ethylene glycol, diethylene glycol, propylene glycol, dipropylene glycol, 1,3-propanediol, 1,4-butanediol, 1,4-butenediol, 1,4-butynediol neopentyl glycol, 1,5-pentanediol, methylpentanediols (such as e.g. 3-methyl-L5-pentanediol), 1,6-hexanediol; 1,8-octanediol, 1,10-decanediol, 1,12-dodecanediol, bis(hydroxymethyl)cyclohexanes (such as e.g. 1,4-bis(hydroxymethyl)cyclohexane), triethylene glycol, tetraethylene glycol, polyethylene glycols, dipropylene glycol, tripropylene glycol, polypropylene glycols, dibutylene glycol and polybutylene glycols); trihydric alcohols (such as e.g. trimethylolpropane, glycerol, trishydroxyethyl isocyanurate, castor oil); tetrahydric alcohols (such as e.g. pentaerythritol); polyalcohols (such as e.g. sorbitol, hexitol, sucrose, starch, starch hydrolysates, cellulose, cellulose hydrolysates, hydroxy-functionalised fats and oils, in particular castor oil), and all modification products of these above-mentioned alcohols with different quantities of ε-caprolactone.

The H-functional starter substances can also be selected from the class of substances of the polyether polyols, in particular those with a molecular weight Mn in the range of 100 to 4000 g/mol. Preferred are polyether polyols that are built up from repeating ethylene oxide and propylene oxide units, preferably with a proportion of 35 to 100% propylene oxide units, particularly preferably with a proportion of 50 to 100% propylene oxide units. These can be random copolymers, gradient copolymers, alternating or block copolymers of ethylene oxide and propylene oxide. Suitable polyether polyols built up from repeating propylene oxide and/or ethylene oxide units are e.g. Desmophen®, Acclaim®, Arcol®, Baycoll®, Bayfill®, Bayflex®Baygal®, PET® and polyether polyols from Bayer MaterialScience AG (such as e.g. Desmophen® 3600Z, Desmophen® 1900U, Acclaim® Polyol 2200, Acclaim® Polyol 40001, Arcol® Polyol 1004, Arcol® Polyol 1010, Arcol® Polyol 1030, Arcol® Polyol 1070, Baycoll® BD 1110, Bayfill® VPPU 0789, Baygal® K55, PET® 1004, Polyether® S180). Further suitable homopolyethylene oxides are e.g. Pluriol® E brands from BASF SE, suitable homopolypropylene oxides are e.g. Pluriol® P brands from BASF SE and suitable mixed copolymers of ethylene oxide and propylene oxide are e.g. Pluronic® PE or Pluriol® RPE brands from BASF SE.

The H-functional starter substances can also be selected from the class of substances of the polyester polyols, in particular those with a molecular weight Mn in the range of 200 to 4500 g/mol. As polyester polyols, at least difunctional polyesters are used. Preferably, polyester polyols consist of alternating acid and alcohol units. As acid components, e.g. succinic acid, maleic acid, maleic anhydride, adipic acid, phthalic anhydride, phthalic acid, isophthalic acid, terephthalic acid, tetrahydrophthalic acid, tetrahydrophthalic anhydride, hexahydrophthalic anhydride or mixtures of the aforementioned acids and/or anhydrides are used. As alcohol components, e.g. ethanediol, 1,2-propanediol, 1,3-propanediol, 1,4-butanediol, 1,5-pentanediol, neopentyl glycol, 1,6-hexanediol, 1,4-bis(hydroxymethyl)cyclohexane, diethylene glycol, dipropylene glycol, trimethylolpropane, glycerol, pentaerythritol or mixtures of the aforementioned alcohols are used. If dihydric or polyhydric polyether polyols are used as the alcohol component, polyester ether polyols are obtained, which can also be used as starter substances for the production of the polyether carbonate polyols. Preferably, polyether polyols with Mn=150 to 2000 g/mol are used for the production of the polyester ether polyols.

Furthermore, polycarbonate diols can be used as H-functional starter substances, in particular those with a molecular weight Mn in the range of 150 to 4500 g/mol, preferably 500 to 2500, which are produced e.g. by reaction of phosgene, dimethyl carbonate, diethyl carbonate or diphenyl carbonate and difunctional alcohols or polyester polyols or polyether polyols. Examples of polycarbonates are found e.g. in EP-A 1359177. For example, Desmophen® C grades from Bayer MaterialScience AG, such as e.g. Desmophen® C 1100 or Desmophen® C 2200, can be used as polycarbonate diols.

In another embodiment of the invention, polyether carbonate polyols can be used as H-functional starter substances. In particular, polyether carbonate polyols that are obtainable by the method according to the invention described here are used. These polyether carbonate polyols used as H-functional starter substances are produced for this purpose in advance in a separate reaction step.

The H-functional starter substances generally have a functionality (i.e. number of H atoms per molecule that are active for polymerisation) of 1 to 8, preferably 2 or 3. The H-functional starter substances are used either individually or as a mixture of at least two H-functional starter substances.

Preferred H-functional starter substances are alcohols of general formula (II),

HO—(CH₂)ₓ—OH (II)

wherein x is a number from 1 to 20, preferably an even number from 2 to 20. Examples of alcohols according to formula (II) are ethylene glycol, 1,4-butanediol, 1,6-hexanediol, 1,8-octanediol, 1,10-decanediol and 1,12-dodecanediol. Other preferred H-functional starter substances are neopentyl glycol, trimethylolpropane, glycerol, pentaerythritol, reaction products of the alcohols according to formula (II) with ε-caprolactone, e.g. reaction products of trimethylolpropane with ε-caprolactone, reaction products of glycerol with ε-caprolactone and reaction products of pentaerythritol with ε-caprolactone. Also preferred as H-functional starter substances are water, diethylene glycol, dipropylene glycol, castor oil, sorbitol and polyether polyols built up from repeating polyalkylene oxide units.

The H-functional starter substances are particularly preferably one or more compounds selected from the group consisting of ethylene glycol, propylene glycol, 1,3-propanediol, 1,3-butanediol, 1,4-butanediol, 1,5-pentanediol, 2-methylpropane-1,3-diol, neopentyl glycol, 1,6-hexanediol, diethylene glycol, dipropylene glycol, glycerol, trimethylolpropane, di- and trifunctional polyether polyols, wherein the polyether polyol is built up from a di- or tri-H-functional starter substance and propylene oxide or a di- or tri-H-functional starter substance, propylene oxide and ethylene oxide. The polyether polyols preferably have a molecular weight Mn in the range of 62 to 4500 g/mol and a functionality of 2 to 3 and in particular a molecular weight Mn in the range of 62 to 3000 g/mol and a functionality of 2 to 3.

The production of the polyether carbonate polyols takes place by catalytic addition of carbon dioxide and alkylene oxides to H-functional starter substances. “H-functional” within the meaning of the invention is understood to be the number of H atoms per molecule of the starter compound that are active for alkoxylation. DMC catalysts for use in the homopolymerisation of epoxides are known in principle from the prior art (cf. e.g. U.S. Pat. No. 3,404,109, U.S. Pat. No. 3,829,505, U.S. Pat. No. 3,941,849 and U.S. Pat. No. 5,158,922). DMC catalysts which are described e.g. in U.S. Pat. No. 5,470,813, EP-A 700 949, EP-A 743 093, EP-A 761 708, WO 97/40086, WO 98/16310 and WO 00/47649 possess very high activity in the homopolymerisation of epoxides and make it possible to produce polyether polyols with very low catalyst concentrations (25 ppm or less), so that separation of the catalyst from the finished product is generally no longer necessary. A typical example are the highly active DMC catalysts described in EP-A 700 949, which in addition to a double metal cyanide compound (e.g. zinc hexacyanocobaltate(III)) and an organic complex ligand (e.g. tert.-butanol) also comprise a polyether with a number average molecular weight greater than 500 g/mol.

The DMC catalysts according to the invention are obtained in that
(i) in the first step, an aqueous solution of a metal salt is reacted with the aqueous solution of a metal cyanide salt in the presence of one or more organic complex ligands, e.g. an ether or alcohol,
(ii) wherein in the second step, the solid is separated from the suspension obtained from (i) by known techniques (such as centrifugation or filtration),
(iii) wherein optionally, in a third step, the isolated solid is washed with an aqueous solution of an organic complex ligand (e.g. by re-suspending and subsequent re-isolation by filtration or centrifugation),
(iv) wherein subsequently the solid obtained, optionally after pulverising, is dried at temperatures of in general 20-120° C. and at pressures of in general 0.1 mbar to standard pressure (1013 mbar),

and wherein, in the first step or immediately after the precipitation of the double metal cyanide compound (second step), one or more organic complex ligands, preferably in excess (based on the double metal cyanide compound), and optionally other complex-forming components are added.

The double metal cyanide compounds comprised in the DMC catalysts according to the invention are the reaction products of water-soluble metal salts and water-soluble metal cyanide salts.

For example, an aqueous solution of zinc chloride (preferably in excess based on the metal cyanide salt, such as e.g. potassium hexacyanocobaltate) and potassium hexacyanocobaltate is mixed and then dimethoxyethane (glyme) or tert-butanol (preferably in excess, based on zinc hexacyanocobaltate) is added to the suspension that has formed.

Suitable metal salts for the production of the double metal cyanide compounds preferably have the general formula (III),

M(X)ₙ (III)

wherein

M is selected from the metal cations Zn²⁺, Fe²⁺, Ni²⁺, Mn²⁺, Co²⁺, Sr²⁺, Sn²⁺, Pb²⁺ and Cu²⁺; M is preferably Zn²⁺, Fe²⁺, Co²⁺ or Ni²⁺,

X is one or more (i.e. different) anions, preferably an anion selected from the group of the halides (i.e. fluoride, chloride, bromide, iodide), hydroxide, sulfate, carbonate, cyanate, thiocyanate, isocyanate, isothiocyanate, carboxylate, oxalate and nitrate;

n is 1 if X=sulfate, carbonate or oxalate and

n is 2 if X=halide, hydroxide, carboxylate, cyanate, thiocyanate, isocyanate, isothiocyanate or nitrate,

or suitable metal salts possess the general formula (IV),

Mᵣ(X)₃ (IV)

wherein

M is selected from the metal cations Fe³⁺, Al³⁺, Co³⁺ and Cr³⁺,

X is one or more (i.e. different) anions, preferably an anion selected from the group of the halides (i.e. fluoride, chloride, bromide, iodide), hydroxide, sulfate, carbonate, cyanate, thiocyanate, isocyanate, isothiocyanate, carboxylate, oxalate and nitrate;

r is 2 if X=sulfate, carbonate or oxalate and

r is 1 if X=halide, hydroxide, carboxylate, cyanate, thiocyanate, isocyanate, isothiocyanate or nitrate,

or suitable metal salts possess the general formula (V),

M(X)ₛ (V)

wherein

M is selected from the metal cations Mo⁴⁺, V⁴⁺ and W⁴⁺

X is one or more (i.e. different) anions, preferably an anion selected from the group of the halides (i.e. fluoride, chloride, bromide, iodide), hydroxide, sulfate, carbonate, cyanate, thiocyanate, isocyanate, isothiocyanate, carboxylate, oxalate and nitrate;

s is 2 if X=sulfate, carbonate or oxalate and

s is 4 if X=halide, hydroxide, carboxylate, cyanate, thiocyanate, isocyanate, isothiocyanate or nitrate,

or suitable metal salts possess the general formula (VI),

M(X)ₜ (VI)

wherein

M is selected from the metal cations Mo⁶⁺ and W⁶⁺

X is one or more (i.e. different) anions, preferably an anion selected from the group of the halides (i.e. fluoride, chloride, bromide, iodide), hydroxide, sulfate, carbonate, cyanate, thiocyanate, isocyanate, isothiocyanate, carboxylate, oxalate and nitrate;

t is 3 if X=sulfate, carbonate or oxalate and

t is 6 if X=halide, hydroxide, carboxylate, cyanate, thiocyanate, isocyanate, isothiocyanate or nitrate.

Examples of suitable metal salts are zinc chloride, zinc bromide, zinc iodide, zinc acetate, zinc acetylacetonate, zinc benzoate, zinc nitrate, iron(II) sulfate, iron(II) bromide, iron(II) chloride, iron(III) chloride, cobalt(II) chloride, cobalt(II) thiocyanate, nickel(II) chloride and nickel(II) nitrate. Mixtures of different metal salts can also be used.

Suitable metal cyanide salts for the production of the double metal cyanide compounds preferably possess the general formula (VII)

(Y)ₐM′(CN)_{b}(A)_{c} (VII)

wherein

M′ is selected from one or more metal cations from the group consisting of Fe(II), Fe(III), Co(II), Co(III), Cr(II), Cr(III), Mn(II), Mn(III), Ir(III), Ni(II), Rh(III), Ru(II), V(IV) and V(V); M′ is preferably one or more metal cations from the group consisting of Co(II), Co(III), Fe(II), Fe(III), Cr(III), Ir(III) and Ni(II),

Y is selected from one or more metal cations from the group consisting of alkali metal (i.e. Li⁺, Na⁺, K⁺, Rb⁺) and alkaline earth metal (i.e. Be²⁺, Mg²⁺, Ca²⁺, Sr²⁺, Ba²⁺),

A is selected from one or more anions from the group consisting of halides (i.e. fluoride, chloride, bromide, iodide), hydroxide, sulfate, carbonate, cyanate, thiocyanate, isocyanate, isothiocyanate, carboxylate, azide, oxalate or nitrate and a, b and c are whole numbers, the values for a, b and c being selected such that there is electroneutrality of the metal cyanide salt; a is preferably 1, 2, 3 or 4; b is preferably 4, 5 or 6; c preferably possesses the value of 0.

Examples of suitable metal cyanide salts are sodium hexacyanocobaltate(III), potassium hexacyanocobaltate(III), potassium hexacyanoferrate(II), potassium hexacyanoferrate(III), calcium hexacyanocobaltate(III) and lithium hexacyanocobaltate(III).

Preferred double metal cyanide compounds that are comprised in the DMC catalysts according to the invention are compounds of the general formula (VIII)

Mₓ[M′ₓ,(CN)_{y}]_{z} (VIII),

wherein M is as defined in formula (III) to (VI) and

M′ is as defined in formula (VII), and

x, y and z are integers and are selected such that there is electroneutrality of the double metal cyanide compound.

Preferably,

x is 3, x′=1, y=6 and z=2,

M=Zn(II), Fe(II), Co(II) or Ni(II) and

M′=Co(III), Fe(III), Cr(III) or Ir(III).

Examples of suitable double metal cyanide compounds a) are zinc hexacyanocobaltate(III), zinc hexacyanoiridate(III), zinc hexacyanoferrate(III) and cobalt(II) hexacyanocobaltate(III). Further examples of suitable double metal cyanide compounds can be taken from e.g. U.S. Pat. No. 5,158,922 (column 8, lines 29-66). Zinc hexacyanocobaltate(III) is particularly preferably used.

The organic complex ligands added during the production of the DMC catalysts are disclosed e.g. in U.S. Pat. No. 5,158,922 (cf. in particular column 6, lines 9 to 65), U.S. Pat. No. 3,404,109, U.S. Pat. No. 3,829,505, U.S. Pat. No. 3,941,849, EP-A 700 949, EP-A 761 708, JP 4 145 123, U.S. Pat. No. 5,470,813, EP-A 743 093 and WO-A 97/40086). As organic complex ligands, for example water-soluble, organic compounds with heteroatoms, such as oxygen, nitrogen, phosphorus or sulfur, which can form complexes with the double metal cyanide compound, are used. Preferred organic complex ligands are alcohols, aldehydes, ketones, ethers, esters, amides, ureas, nitriles, sulfides and mixtures thereof. Particularly preferred organic complex ligands are aliphatic ethers (such as dimethoxyethane), water-soluble aliphatic alcohols (such as ethanol, isopropanol, n-butanol, iso-butanol, sec.-butanol, tert.-butanol, 2-methyl-3-buten-2-ol and 2-methyl-3-butyn-2-ol) and compounds which comprise both aliphatic or cycloaliphatic ether groups and aliphatic hydroxyl groups (such as e.g. ethylene glycol mono-tert.-butyl ether, diethylene glycol mono-tert.-butyl ether, tripropylene glycol mono-methyl ether and 3-methyl-3-oxetane methanol). Most preferred organic complex ligands are selected from one or more compounds from the group consisting of dimethoxyethane, tert-butanol 2-methyl-3-buten-2-ol, 2-methyl-3-Butyn-2-ol, ethylene glycol mono-tert.-butyl ether and 3-methyl-3-oxetane methanol.

Optionally in the production of the DMC catalysts according to the invention, one or more complex-forming component(s) are used from the classes of compounds of the polyethers, polyesters, polycarbonates, polyalkylene glycol sorbitan esters, polyalkylene glycol glycidyl ethers, polyacrylamide, poly(acrylamide-co-acrylic acid), polyacrylic acid, poly(acrylic acid-co-maleic acid), polyacrylonitrile, polyalkyl acrylates, polyalkyl methacrylates, polyvinyl methyl ether, polyvinyl ethyl ether, polyvinyl acetate, polyvinyl alcohol, poly-N-vinylpyrrolidone, poly(N-vinylpyrrolidone-co-acrylic acid), polyvinyl methyl ketone, poly(4-vinylphenol), poly(acrylic acid-co-styrene), oxazoline polymers, polyalkylene imines, maleic acid and maleic anhydride copolymers, hydroxyethyl cellulose and polyacetals, or the glycidyl ethers, glycosides, carboxylic acid esters of polyhydric alcohols, bile acids or salts, esters or amides thereof, cyclodextrins, phosphorus compounds, α,β-unsaturated carboxylic acid esters or ionic surface-active or interfacially active compounds.

In the production of the DMC catalysts according to the invention, in the first step the aqueous solutions of the metal salt (e.g. zinc chloride), used in a stoichiometric excess (at least 50 mole %) based on metal cyanide salt, i.e. at least a molar ratio of metal salt to metal cyanide salt of 2.25 to 1.00, and of the metal cyanide salt (e.g. potassium hexacyanocobaltate) are preferably reacted in the presence of the organic complex ligand (e.g. tert.-butanol), forming a suspension which comprises the double metal cyanide compound (e.g. zinc hexacyanocobaltate), water, excess metal salt and the organic complex ligand.

The organic complex ligand can be present here in the aqueous solution of the metal salt and/or of the metal cyanide salt, or it is added directly to the suspension that is obtained after precipitation of the double metal cyanide compound. It has proved advantageous to mix the aqueous solutions of the metal salt and of the metal cyanide salt and the organic complex ligand with vigorous stirring. Optionally, the suspension that is formed in the first step is then treated with another complex-forming component. The complex-forming component here is preferably used in a mixture with water and organic complex ligand. A preferred method for carrying out the first step (i.e. the production of the suspension) takes place using a mixing nozzle, particularly preferably using a jet disperser as described in WO-A 01/39883.

In the second step, the isolation of the solid (i.e. the precursor of the catalyst according to the invention) from the suspension takes place by known techniques, such as centrifugation or filtration.

In a preferred variant, the isolated solid is then washed with an aqueous solution of the organic complex ligand in a third step of the method (e.g. by re-suspending and subsequent re-isolation by filtration or centrifugation). In this way, for example water-soluble by-products, such as potassium chloride, can be removed from the catalyst according to the invention. The quantity of the organic complex ligand in the aqueous washing solution is preferably between 40 and 80 wt. %, based on the overall solution.

Optionally in the third step, further complex-forming component is added to the aqueous washing solution, preferably in the range of between 0.5 and 5 wt. %, based on the overall solution.

In addition, it is advantageous to wash the isolated solid more than once. Preferably in a first washing step (iii-1) washing is carried out with an aqueous solution of the unsaturated alcohol (e.g. by re-suspending and subsequent re-isolation by filtration or centrifugation) in order to remove for example water-soluble by-products, such as potassium chloride, from the catalyst according to the invention in this way. Particularly preferably, the quantity of the unsaturated alcohol in the aqueous washing solution is between 40 and 80 wt. %, based on the overall solution from the first washing step. In the other washing steps (iii-2), either the first washing step is repeated one or more times, preferably one to three times, or preferably a non-aqueous solution, such as e.g. a mixture or solution of unsaturated alcohol and other complex-forming component (preferably in the range of between 0.5 and 5 wt. %, based on the total quantity of the washing solution from step (iii-2)), is used as the washing solution and the solid is washed with this one or more times, preferably one to three times.

The isolated and optionally washed solid is then dried, optionally after pulverising, at temperatures of in general 20 to 100° C. and pressures of in general 0.1 mbar to standard pressure (1013 mbar).

A preferred method for isolating the DMC catalysts according to the invention from the suspension by filtration, filter cake washing and drying is described in WO-A 01/80994.

For the production of the flexible polyurethane foams, the reaction components are reacted by the one-step method which is known per se, often employing mechanical devices, e.g. those that are described in EP-A 355 000. Details of processing devices which are also suitable according to the invention are described in KunststoffHandbuch, volume VII, edited by Vieweg and Hochtlen, Carl-Hanser-Verlag, Munich 1993, e.g. on pp. 139 to 265.

The flexible polyurethane foams can be produced as moulded or slabstock foams; the flexible polyurethane foams are preferably produced as moulded foams in the cold foaming process. The invention therefore provides a method for producing the flexible polyurethane foams, the flexible polyurethane foams produced by this method, the slabstock flexible polyurethane foams or moulded flexible polyurethane foams produced by this method, the use of the flexible polyurethane foams for producing mouldings and the mouldings themselves. The flexible polyurethane foams that can be obtained according to the invention have e.g. the following applications: furniture upholstery, textile inserts, mattresses, car seats, head rests, arm rests, sponges and construction elements.

The index gives the percentage ratio of the quantity of isocyanate actually used to the stoichiometric quantity, i.e. the quantity of isocyanate groups (NCO) calculated for the conversion of the OH equivalents.

Index=[(isocyanate quantity used):(isocyanate quantity calculated)]·100 (IX)

The present invention is explained further on the basis of the following examples.

### EXAMPLES

The materials and abbreviations used have the following meanings:
DABCO® (triethylenediamine; 2,2,2-diazabicyclooctane): Aldrich
A1-1: polyether polyol with an OH value of 28 mg KOH/g, produced in the presence of KOH as catalyst by addition of propylene oxide and ethylene oxide in a ratio of 85 to 15 using glycerol as starter with 85 mole % primary OH groups.
A1-2: polyether polyol with an OH value of 37 mg KOH/g, produced by addition of propylene oxide and ethylene oxide in a ratio of 27 to 73 using glycerol as starter with approx. 83 mole % primary OH groups.
A3-1 Tegostab® B 8715LF, preparation of organo-modified polysiloxanes, Evonik Goldschmidt.
A3-2 Jeffcat® ZR50, amine catalyst from Huntsman Corp. Europe.
A-3-3 Dabco® NE300, amine catalyst from Air Products.
A4-1 Diethanolamine
B1-1 Mixture comprising 59.2 wt. % 4,4′-diphenylmethane diisocyanate, 20.2 wt. % 2,4′-diphenylmethane diisocyanate and 17.8 wt. % polyphenyl polymethylene polyisocyanate (“polynuclear MDI”) with an NCO content of 32.5 wt. %.
B1-2 Mixture comprising 69.0 wt. % 4,4′-diphenylmethane diisocyanate, 9.3 wt. % 2,4′-diphenylmethane diisocyanate and 20.5 wt. % polyphenyl polymethylene polyisocyanate (“polynuclear MDI”) with an NCO content of 32.5 wt. %.
B2-2 Polyether polyol with an OH value of 56 mg KOH/g and <10 mole % primary OH groups, produced in the presence of KOH as catalyst by addition of propylene oxide using glycerol as starter.
B2-3 Polyether polyol with an OH value of 56 mg KOH/g and <10 mole % primary OH groups, produced in the presence of a DMC catalyst by addition of propylene oxide using glycerol as starter.

The analyses were carried out as follows:

Dynamic viscosity: MCR 51 rheometer from Anton Paar according to DIN 53019.

NCO content: based on the standard DIN 53185

The density was determined according to DIN EN ISO 3386-1-98.

The compressive strength was determined according to DIN EN ISO 3386-1-98 (at 40% deformation and 4^{th} cycle).

The tensile strength and elongation at break were determined according to DIN EN ISO 1798.

The compression sets CS 50% (Ct) and CS 75% (Ct) were determined according to DIN EN ISO 1856-2001-03 at 50% and 75% deformation respectively.

The loss of hardness after 3 h ageing in a steam autoclave at 105° C. (HALL) was determined by the method GM6293M, ASTM D3574-C, J.

The tear propagation resistance was determined according to DIN EN ISO 8067.

The weight and number average of the molecular weight of the polyether carbonate polyols was determined by gel permeation chromatography (GPC). The procedure followed was in accordance with DIN 55672-1: “Gel permeation chromatography, Part 1—tetrahydrofuran as eluent”. Polystyrene samples of known molar mass were used for calibration purposes.

The OH value (hydroxyl value) was determined on the basis of DIN 53240-2, but using pyridine instead of THF/dichloromethane as solvent. Titration was performed with 0.5 molar ethanolic KOH (end point determination by potentiometry). Castor oil with certified OH value acted as the test substance. The statement of the unit in “mg/g” refers to mg [KOH]/g [polyol].

Determination of the molar proportion of primary OH groups: by ¹H-NMR (Bruker DPX 400, deuterochloroform)

Hydroxyl value: based on the standard DIN 53240

Acid value: based on the standard DIN 53402

The ratio of primary and secondary OH groups was determined by ¹H-NMR (Bruker DPX 400, deuterochloroform).

The proportion of incorporated CO₂ in the resulting polyether carbonate polyol and the ratio of propylene carbonate to polyether carbonate polyol were determined by ¹H-NMR (Bruker, DPX 400, 400 MHz; pulse program zg30, delay d1: 10 s, 64 scans). The sample was dissolved in deuterated chloroform in each case. The relevant resonances in the ¹H-NMR (based on TMS=0 ppm) are as follows:

Cyclic carbonate (which was formed as a by-product) with resonance at 4.5 ppm, carbonate, resulting from carbon dioxide incorporated in the polyether carbonate polyol with resonances at 5.1 to 4.8 ppm, unreacted PO with resonance at 2.4 ppm, polyether polyol (i.e. without any incorporated carbon dioxide) with resonances at 1.2 to 1.0 ppm.

The molar proportion of carbonate incorporated in the polymer in the reaction mixture is calculated according to formula (X) as follows, wherein the following abbreviations are used:
F(4.5)=area of resonance at 4.5 ppm for cyclic carbonate (corresponds to an H atom)
F(5.1-4.8)=area of resonance at 5.1-4.8 ppm for polyether carbonate polyol and an H atom for cyclic carbonate.
F(2.4)=area of resonance at 2.4 ppm for free, unreacted PO
F(1.2-1.0)=area of resonance at 1.2-1.0 ppm for polyether polyol

Taking into account the relative intensities, for the polymer bound carbonate (“linear carbonate” LC) in the reaction mixture a conversion to mole % was performed according to the following formula (X):

$$LC = \frac{F ( 5.1 - 4.8 ) - F ( 4.5 )}{\begin{matrix}F ( 5.1 - 4.8 ) + F ( 2.4 ) + 0.33 * \\ F ( 1.2 - 1.0 ) + 0.25 * F ( 1.6 - 1.52 )\end{matrix}} * 100 \qquad ( X )$$

The proportion by weight (in wt. %) of polymer-bound carbonate (LC′) in the reaction mixture was calculated according to formula (XI),

$${LC}^{′} = \frac{[ F ( 5.1 - 4.8 ) - F ( 4.5 ) ] * 102}{N} * 100 \% \qquad ( XI )$$

wherein the value of N (“denominator” N) is calculated according to formula (XII):

N=[F(5.1−4.8)−F(4.5)]*102+F(4.5)*102+F(2.4)*58+0.33*F(1.2−1.0)*58+0.25*F(1.6−1.52)*146 (XII)

The factor 102 results from the sum of the molar masses of CO₂ (molar mass 44 g/mol) and that of propylene oxide (molar mass 58 g/mol), the factor 58 results from the molar mass of propylene oxide and the factor 146 results from the molar mass of the starter used, 1,8-octanediol.

The proportion by weight (in wt. %) of cyclic carbonate (CC′) in the reaction mixture was calculated according to formula (XIII),

$${CC}^{′} = \frac{F ( 4.5 ) * 102}{N} * 100 \% \qquad ( XIII )$$

wherein the value of N is calculated according to formula (XII).

In order to calculate the composition based on the polymer proportion (consisting of polyether polyol, which was built up from starter and propylene oxide during the activation steps taking place under CO₂-free conditions, and polyether carbonate polyol, built up from starter, propylene oxide and carbon dioxide during the activation steps taking place in the presence of CO₂ and during the copolymerisation) from the values of the composition of the reaction mixture, the non-polymer constituents of the reaction mixture (i.e. cyclic propylene carbonate and any unreacted propylene oxide present) were eliminated by calculation. The proportion by weight of the carbonate repeating units in the polyether carbonate polyol was converted to a proportion by weight of carbon dioxide by means of the factor F=44/(44+58). The statement of the CO₂ content in the polyether carbonate polyol is standardised to the proportion of the polyether carbonate polyol molecule that was formed during the copolymerisation and optionally the activation steps in the presence of CO₂ (i.e. the proportion of the polyether carbonate polyol molecule that results from the starter (trifunctional poly(oxypropylene)polyol with OH value=235 mg KOH/g) and from the reaction of the starter with propylene oxide, which was added under CO₂-free conditions, was not taken into account here).

Production of the Polyether Carbonate Polyol B2-1:

A 12-litre pressure reactor with a gas metering device was initially charged with 1.3 g of dried DMC catalyst (produced according to example 6 of WO-A 01/80994), 0.6 g 4-tert-butyl-catechol and 1010 g of a dried trifunctional poly(oxypropylene)polyol with OH value=235 mg KOH/g as starter. The reactor was heated up to 130° C. and rendered inert by repeated pressurising with nitrogen to approx. 5 bar and subsequent pressure release to approx. 1 bar. This procedure was performed 3 times. At 130° C. and in the absence of CO₂, 255 g of propylene oxide (PO) were metered into the reactor at 10 g/min. The start-up of the reaction became apparent by a temperature peak (“hotspot”) and by a pressure drop to approximately the starting pressure (approx. 1 bar). After the first pressure drop, 203 g PO were metered in at 10 g/min and then 191 g PO at 10 g/min, a hotspot and a pressure drop occurring again in each case. After the reactor had been pressurised with 50 bar CO₂, 505 g PO were metered in at 10 g/min, resulting in the occurrence of a hotspot after a further delay. At the same time, the carbon dioxide CO₂ pressure began to drop. The CO₂ pressure was then increased to 90 bar. The pressure during the rest of the test was regulated such that when it fell below the target value, new CO₂ was added. Only then was the remaining propylene oxide (3506 g) pumped into the reactor continuously within 12 hours, while after 10 minutes the temperature was reduced in steps of 5° C. per five minutes from 130° C. to 105° C. On completion of the PO addition, stirring was continued for a further 60 minutes at 105° C. and under the above-mentioned pressure. Finally, volatile constituents were removed from the product by thin film evaporation.

The OH value of the resulting polyether carbonate polyol B2-1 was 59 mg KOH/g and it had a viscosity (23° C.) of 9610 mPas. The CO₂ content in the product was 17.5 wt. %.

Production of the NCO-Terminated, Urethane Group-Comprising Prepolymer B-1:

In a first step, 1825 g of component B1-2 were mixed with 15 g polyether polyol A1-2 and with 160 g of the polyether carbonate polyol B2-1 for 2 min with a stirrer and then left to stand for 24 h at 25° C. The resulting product was then mixed for 3 min and the NCO content determined.

NCO content: 26.2 wt. %

In a second step, 2000 g of the product resulting from the first step was mixed with 2000 g of component B1-1 for 2 min with a stirrer and then left to stand for 1 h at 25° C. The resulting prepolymer was then mixed for 2 min with a stirrer and the NCO content determined.

NCO content: 29.4 wt. %

Production of the NCO-Terminated, Urethane Group-Comprising Prepolymer B-2 (Comparison):

In a first step, 1825 g of component B1-2 were mixed with 15 g of polyether polyol A1-2 and with 160 g of the polyether polyol B2-2 for 2 min with a stirrer and then left to stand for 24 h at 25° C. The resulting product was then mixed for 3 min and the NCO content determined.

NCO content: 26.3 wt. %

In a second step, 2000 g of the product resulting from the first step was mixed with 2000 g of component B1-1 for 2 min with a stirrer and then left to stand for 1 h at 25° C. The resulting prepolymer was then mixed for 2 min with a stirrer and the NCO content determined.

NCO content: 29.4 wt. %

Production of the NCO-Terminated, Urethane Group-Comprising Prepolymer B-3 (Comparative Example):

In a first step, 1825 g of component B1-2 were mixed with 15 g of polyether polyol A1-2 and with 160 g of the polyether polyol B2-3 for 2 min with a stirrer and then left to stand for 24 h at 25° C. The resulting product was then mixed for 3 min and the NCO content determined.

NCO content: 26.3 wt. %

In a second step, 2000 g of the product resulting from the first step were mixed with 2000 g of component B1-1 for 2 min with a stirrer and then left to stand for 1 h at 25° C. The resulting prepolymer was then mixed for 2 min with a stirrer and the NCO content determined.

NCO content: 29.4 wt. %

Production of the Isocyanate Mixture B-4 (Comparative Example):

1825 g of component B1-2 and 2000 g of component B1-1 were mixed for 2 min with a stirrer and then left to stand for 1 h at 25° C. The mixture was then mixed for 2 min with a stirrer and the NCO content determined.

NCO content: 32.5 wt. %

Production of Moulded Flexible Polyurethane Foams

In a processing method that is conventional for the production of moulded flexible polyurethane foams in the cold foaming process by the one-step method, the feedstocks listed in the examples in Table 1 below are reacted together. The reaction mixture is introduced into a metal mould with a volume of 9.7 l which is heated to 60° C., and demoulded after 4 min. The quantity of the raw materials used was selected so that a calculated moulding density of about 51 kg/m³ results. Table 1 gives the moulding density actually obtained, which was determined according to DIN EN ISO 3386-1-98.

TABLE 1
Production and evaluation of the moulded flexible polyurethane foams

| | | 1 | 2 | | 4 |
|---|---|---|---|---|---|
| | | (comp.) | (comp.) | 3 | (comp.) |
| A1-1 | [pts. by wt.] | 94.03 | 94.03 | 94.03 | 94.03 |
| B2-1 | | | | | 4.74 |
| A1-2 | | | | | 0.44 |
| Water | [pts. by wt.] | 3.43 | 3.43 | 3.43 | 3.43 |
| A3-1 | [pts. by wt.] | 0.94 | 0.94 | 0.94 | 0.94 |
| A3-2 | [pts. by wt.] | 0.38 | 0.38 | 0.38 | 0.38 |
| A3-3 | [pts. by wt.] | 0.09 | 0.09 | 0.09 | 0.09 |
| A4-1 | [pts. by wt.] | 1.13 | 1.13 | 1.13 | 1.13 |
| Index | | 90 | 90 | 90 | 90 |
| B-1 | [MR] | | | 59.19 | |
| B-2 | [MR] | 59.15 | | | |
| B-3 | [MR] | | 59.15 | | |
| B-4 | | | | | 54.0 |
| Properties | | | | | |
| Density | [kg/m³] | 51.0 | 51.5 | 51.3 | 51.4 |
| Compressive strength | [kPa] | 7.7 | 8.0 | 7.9 | 6.1 |
| Tensile strength | [kPa] | 115 | 107 | 124 | 109 |
| Elongation at break | [%] | 83.0 | 80.5 | 90.0 | 78.0 |
| CS 50% | Ct[%] | 6.9 | 7.2 | 7.1 | 8.1 |
| CS 75% | Ct[%] | 8.7 | 9.0 | 9.6 | 11.4 |
| HALL | [%] | −9.5 | −9.8 | −9.3 | |
| Tear propagation resistance | [N/mm] | 0.232 | 0.258 | 0.261 | |

Abbreviations:
comp. = comparative example;
pts. by wt. = parts by weight;
MR = weight ratio of component A to component B at the index stated and based on 100 parts by weight of component A; in the case of comparative examples 1 and 2, the component B2-1 (polyricinoleic acid ester) used in the polyol formulation is added to component A and thus also to the sum of the parts by weight of component A.

The moulded flexible polyurethane foam according to the invention (example 3), in which the polyether carbonate polyol was processed in the form of a prepolymer, permitted the production of moulded flexible foams in good surface quality and with good mechanical properties. Comparative example 4 is softer and exhibits a higher compression set (CS) than the moulded flexible polyurethane foam according to the invention (example 3).

1-15. (canceled)

16. A method for producing a flexible polyurethane foam comprising reacting component A comprising
A1 100 parts by weight of polyether polyol,
A2 0.5 to 25 parts by weight (based on 100 parts by weight of component A1) water and/or a physical blowing agent, and
A3 0.05 to 10 parts by weight (based on 100 parts by weight of component A1) auxiliary substance and/or additive
a) a catalyst,
b) a surface-active additive,
c) a pigment or flame retardant,
with an NCO-terminated, urethane group-comprising prepolymer (component B) comprising one or more polyisocyanate (B1) and one or more polyether carbonate polyol (B2),
the production taking place at an index of 50 to 250.

17. A method for producing a flexible polyurethane foam, comprising
(i) in a first step, adding one or more alkylene oxide and carbon dioxide to one or more H-functional starter substance in the presence of at least one DMC catalyst,
(ii) in a second step, reacting one or more polyisocyanate (B1) with the polyether carbonate polyol (B2) formed in step (i) to form an NCO-terminated, urethane group-comprising prepolymer (B), and
(iii) in a third step, producing a flexible polyurethane foam by reacting component A (polyol formulation) comprising
A1 100 parts by weight polyether polyol,
A2 0.5 to 25 parts by weight (based on 100 parts by weight of component A1) water and/or a physical blowing agent, and
A3 0.05 to 10 parts by weight (based on 100 parts by weight of component A1) auxiliary substance and/or additive
a) a catalyst,
b) a surface-active additive,
c) a pigment or flame retardant,
with component B resulting from step (ii),
wherein the production of the flexible polyurethane foam takes place at an index of 50 to 250.

18. The method according to claim 16, wherein component A is free from polyether carbonate polyols.

19. The method according to claim 16, wherein component A additionally comprises
A4 0 to 10 parts by weight (based on 100 parts by weight of component A1) isocyanate-reactive compound comprising a hydrogen atom with a molecular weight of 62-399.

20. The method according to claim 16, wherein one or more alkylene oxide addition product of starter compound with Zerewitinoff-active hydrogen atom is used as polyether polyol A1.

21. The method according to claim 16, wherein the polyether polyol A1 comprises one or more alkylene oxide addition product, obtained by reaction of at least one starter compound selected from the group consisting of propylene glycol, ethylene glycol, diethylene glycol, dipropylene glycol, 1,2-butanediol, 1,3-butanediol, 1,4-butanediol, hexanediol, pentanediol, 3-methyl-1,5-pentanediol, 1,12-dodecanediol, glycerol, trimethylolpropane, triethanolamine, pentaerythritol, sorbitol, sucrose, hydroquinone, pyrocatechol, resorcinol, bisphenol F, bisphenol A, 1,3,5-trihydroxybenzene and methylol group-comprising condensates of formaldehyde and phenol, methylol group-comprising condensates of formaldehyde melamine, methylol group-comprising condensates of formaldehyde, and urea, with at least one alkylene oxide selected from the group consisting of ethylene oxide, propylene oxide, 1,2-butylene oxide, 2,3-butylene oxide, and styrene oxide.

22. The method according to claim 16, wherein component B1 comprises at least one compound selected from the group consisting of 2,4-toluene diisocyanate, 2,6-toluene diisocyanate, 4,4′-diphenylmethane diisocyanate, 2,4′-diphenylmethane diisocyanate, 2,2′-diphenylmethane diisocyanate, and polyphenyl polymethylene polyisocyanate.

23. The method according to claim 16, wherein the NCO-terminated, urethane group-comprising prepolymer (B) is obtained by reacting
B1) a polyisocyanate consisting of at least one component selected from the group consisting of 4,4′-diphenylmethane diisocyanate, 2,4′-diphenylmethane diisocyanate, 2,2′-diphenylmethane diisocyanate, and polyphenyl polymethylene polyisocyanate with
B2) one or more polyether carbonate polyol.

24. The method according to claim 16, wherein the polyether carbonate polyol (B2) has an OH functionality of 2 to 6.

25. The method according to claim 16, wherein the polyether carbonate polyol (B2) is obtained by adding one or more alkylene oxide and carbon dioxide to one or more H-functional starter substance in the presence of at least one DMC catalyst.

26. The method according to claim 16, wherein the flexible polyurethane foam is produced as moulded foam in a cold foaming process.

27. A flexible polyurethane foam with a density according to DIN EN ISO 3386-1-98 in the range of ≧10 kg/m³ to ≦300 kg/m³ and a compressive strength according to DIN EN ISO 3386-1-98 in the range of ≧0.5 kPa to ≦20 kPa (at 40% deformation and 4th cycle) obtained by a method according to claim 16.

28. A method for producing a NCO-terminated, urethane group-comprising prepolymer, comprising
(i) in a first step, adding one or more alkylene oxide and carbon dioxide to one or more H-functional starter substance in the presence of at least one DMC catalyst, and
(ii) in a second step, reacting one or more polyisocyanates (B1) with the polyether carbonate polyol (B2) formed in step (i).

29. An NCO-terminated, urethane group-comprising prepolymer obtained by reaction of one or more polyisocyanates (B1) with one or more polyether carbonate polyol (B2).

30. The NCO-terminated, urethane group-comprising prepolymer according to claim 29 obtained by reacting
B1) a polyisocyanate consisting of at least one component selected from the group consisting of 4,4′-diphenylmethane diisocyanate, 2,4′-diphenylmethane diisocyanate, 2,2′-diphenylmethane diisocyanate, and polyphenyl polymethylene polyisocyanate with
B2) one or more polyether carbonate polyol.
